(19) United States
(12) Patent Application Publication
(10) Pub. No.: US 2026/0081061 A1
(43) Pub. Date: Mar. 19, 2026

(54) Coupled Inductor

(71) Applicant: CYNTEC CO., LTD., Hsinchu (TW)

(72) Inventors: Chi-Shiuan Shie, Hsinchu (TW); Chia-Hsing Chou, Hsinchu (TW)

(73) Assignee: CYNTEC CO., LTD., Hsinchu (TW)

(21) Appl. No.: 19/324,064

(22) Filed: Sep. 9, 2025

Related U.S. Application Data
(60) Provisional application No. 63/694,219, filed on Sep. 13, 2024.

(51) Int. Cl. H01F 27/24; H01F 27/28

(52) U.S. Cl. CPC H01F 27/24; H01F 27/28

(57) ABSTRACT

A coupled inductor includes a core assembly, at least two first windings, and a second winding. The core assembly includes a first core and a second core. The first core includes a first base plate, two first non-winding posts, and at least two first winding posts disposed between the two first non-winding posts. The two first non-winding posts and the first winding posts are connected to the first base plate. Each of the first windings is wound around a corresponding first winding post. The second winding covers the at least two first windings. The at least two first windings and the second winding are disposed along a first direction. A first wound direction of the at least two first windings and a second wound direction of the second winding are parallel to each other.

### CROSS REFERENCE TO RELATED APPLICATIONS

This application claims the benefit of U.S. Provisional Application No. 63/694,219, filed on September 13th, 2024. The content of the application is incorporated herein by reference.

### BACKGROUND OF THE INVENTION

### 1. FIELD OF THE INVENTION

The present invention relates to an electronic component, and more particularly to a coupled inductor applied in a power conversion system.

### 2. DESCRIPTION OF THE RELATED ART

With the rapid development of information technology, the power consumption and current demand of high-performance computing units such as central processing units (CPUs), graphics processing units (GPUs), and various application-specific integrated circuits (ASICs) are continuously increasing. For these computing units to achieve high-efficiency operation under different load conditions, their core voltage (Vcore) needs to be dynamically adjusted in a very short period, and the transient variation of current consumption is also extremely drastic, potentially jumping from a low current at a light load to a high current at a heavy load within a few microseconds. Traditional Voltage Regulator Modules (VRMs) face significant challenges in coping with such severe load transients. To maintain the stability of the core voltage, conventional designs often require a large number of decoupling capacitors to be connected in parallel at the output, which not only occupies valuable Printed Circuit Board (PCB) area but also increases the overall system cost.

To address this issue, an advanced architecture called the Trans-Inductor Voltage Regulator (TLVR) has been proposed in the industry. The TLVR architecture, by introducing a coupled inductor (or compensation inductor) between the main inductors of a traditional multiphase buck converter, utilizes the magnetic coupling effect between inductors. This allows the inductors of all phases to act in concert to respond to changes in load current when a load transient occurs. Compared to the conventional VRM approach where each phase operates independently, the TLVR architecture can significantly improve the transient response speed of the system, thereby substantially reducing the need for output capacitors, saving PCB area, and lowering costs.

However, existing implementations of the TLVR architecture still have some inherent disadvantages. In a typical TLVR circuit, each power phase requires an independent main inductor, and an additional compensation inductor must be connected to the output terminals of all main inductors. For example, an eight-phase TLVR system would require eight independent main inductors and one compensation inductor. This approach of using multiple discrete inductor components, while offering improved electrical performance, introduces new challenges in terms of component layout and space utilization. These discrete inductors occupy a considerable amount of PCB area, which becomes a major bottleneck in system design, especially in the densely populated regions around a CPU or GPU. Furthermore, the layout and routing of multiple components increase the complexity of PCB design and may introduce additional parasitic inductance and resistance, thereby affecting the overall efficiency and performance of the system.

Consequently, the industry has begun to seek solutions that integrate the functions of the multiphase main inductors and the coupled compensation inductor into a single component. Some existing integrated coil devices may enhance magnetic coupling through the overlapping configuration of a double-layer conductor. However, the structures of these prior art devices focus primarily on the coupling between two conductors and do not provide an optimal solution for effectively integrating multiple power phases into a single magnetic core while simultaneously achieving the high-performance transient response required by architectures like TLVR. When implementing multiphase integration, their structures may face issues such as complex magnetic path design, difficulty in controlling the symmetry between phases, and challenges in optimizing direct current resistance (DCR).

Therefore, there is an urgent need for a new coupled inductor structure that not only integrates multiple power phases within a single package to significantly reduce volume and save PCB space, but also maintains or even surpasses the excellent transient response characteristics of the traditional TLVR architecture. Additionally, this structure should possess low direct current resistance, good thermal performance, and ease of manufacturing to meet the increasingly stringent requirements for power solutions in next-generation high-performance computing systems.

### SUMMARY OF THE INVENTION

An embodiment of the present invention provides a coupled inductor, which includes a core component, at least two first windings, and a second winding. The core component includes a first core and a second core. The first core includes a first substrate, two first non-winding posts, and at least two first winding posts disposed between the two first non-winding posts. The two first non-winding posts and the first winding posts are connected to the first substrate. Each first winding is wound on a corresponding first winding post. The second winding covers the at least two first windings. The at least two first windings and the second winding are disposed along a first direction. A first winding direction of the at least two first windings and a second winding direction of the second winding are mutually parallel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view of a coupled inductor according to a first embodiment of the present invention.

FIG. 2 is an exploded perspective view of the coupled inductor shown in FIG. 1.

FIG. 3 is a cross-sectional schematic view of the coupled inductor shown in FIG. 1, taken along line 3-3'.

FIG. 4 is a perspective view of the first core shown in FIG. 2.

FIG. 5 is an exploded perspective view of a first winding shown in FIG. 2.

FIG. 6 is a perspective view of the first winding shown in FIG. 2 from another angle.

FIG. 7 illustrates schematic diagrams of different shape designs for the inner bottom plate of a first winding.

FIG. 8 illustrates schematic diagrams of different gap configurations for the coupled inductor.

FIG. 9 illustrates schematic diagrams of different embodiments for the terminal extension structure of a first winding.

FIG. 10 is an exploded perspective view of a coupled inductor according to a second embodiment of the present invention.

FIG. 11 is a cross-sectional schematic view of the coupled inductor shown in FIG. 10.

FIG. 12 is a perspective view of a first winding shown in FIG. 10.

FIG. 13 is a perspective view of the winding and terminal configuration of the coupled inductor shown in FIG. 10 from another angle.

FIG. 14 is a perspective view of a winding structure according to another embodiment of the present invention.

### DETAILED DESCRIPTION

To make the technical content of the present invention clearer, preferred embodiments of the present invention are described in detail below with reference to the drawings. It must be noted that the embodiments described herein are only a part of the many possible implementations of the present invention and are intended for illustrative purposes, not to limit the scope of protection of the present invention. For the interpretation of the patent claims, the content recited in the claims should be the standard, rather than being limited to the description of the embodiments. Furthermore, for clarity and ease of understanding of the illustrations, the dimensions and relative proportions of the components in the figures may be simplified or exaggerated and are not necessarily drawn to actual scale. Identical or similar reference numerals in the drawings represent identical or similar components.

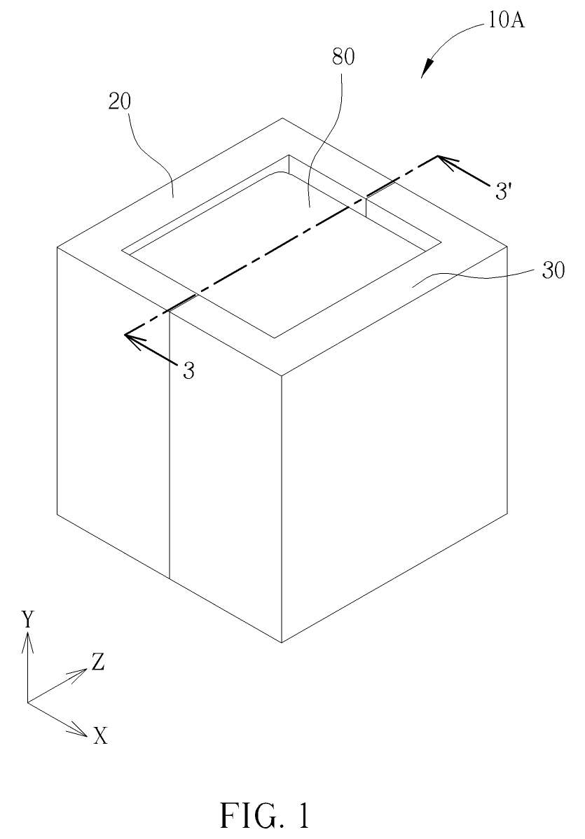

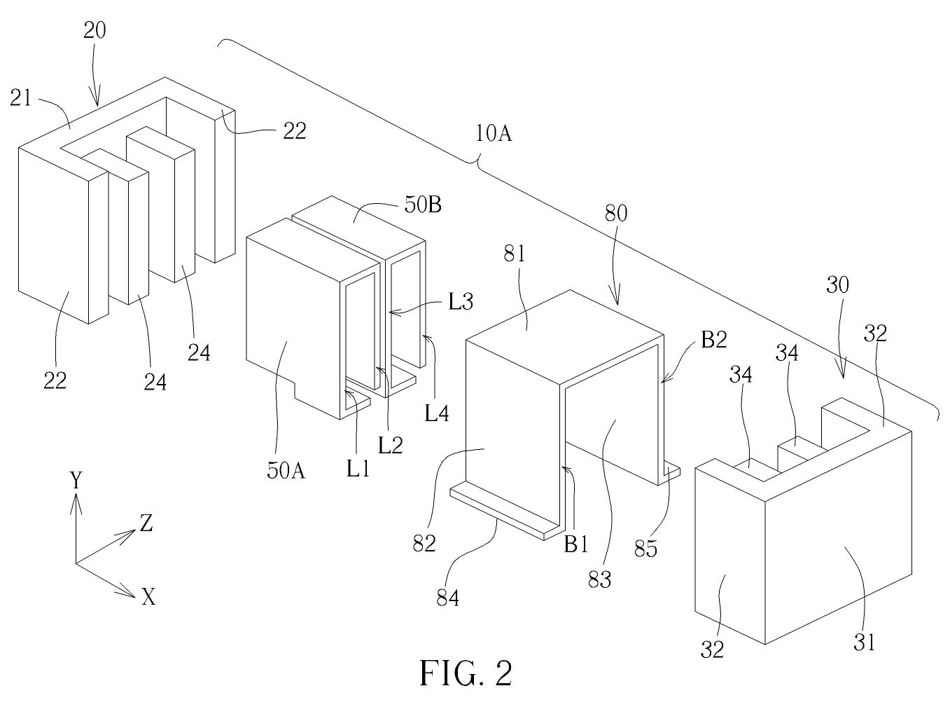

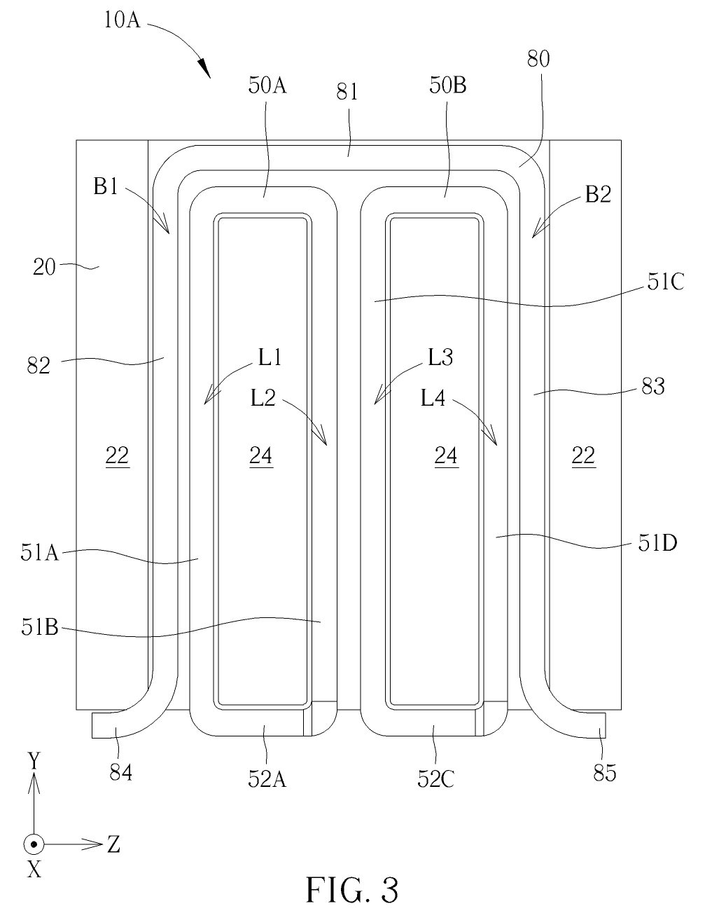

Please refer to FIG. 1, FIG. 2, and FIG. 3, which respectively illustrate a perspective view, an exploded perspective view, and a cross-sectional schematic view of a coupled inductor 10A according to a first embodiment of the present invention. The coupled inductor 10A of this embodiment is a highly integrated two-phase inductor component, designed to replace two discrete main inductors and one compensation inductor in a conventional TLVR architecture. The coupled inductor 10A mainly includes a core component, two first windings 50A, 50B, and one second winding 80. In circuit applications, these first windings 50A, 50B usually serve as primary windings, while the second winding 80 serves as an auxiliary winding or secondary winding. In a three-dimensional coordinate system, directions are defined by three mutually perpendicular axes X, Y, and Z.

The core component of the coupled inductor 10A includes a first core 20 and a second core 30. These two cores 20, 30 are typically made of a ferromagnetic material with high magnetic permeability and low magnetic loss, such as ferrite or an alloy powder core, and can be processed through methods such as molding or sintering.

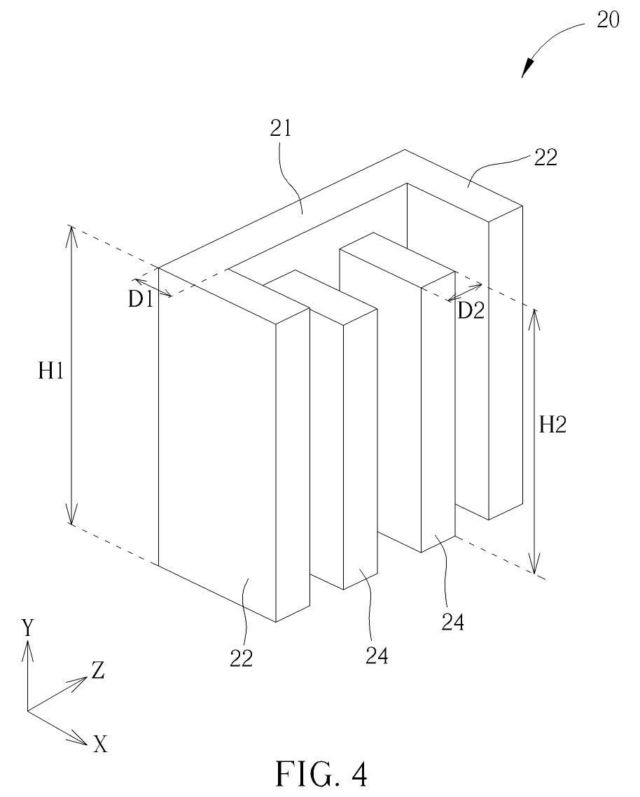

Please refer to FIG. 2 and FIG. 4 simultaneously. The first core 20 has an integrally formed structure, which includes a first substrate 21, two first non-winding posts 22 disposed on two sides, and two first winding posts 24 disposed between the two first non-winding posts 22. Both the two first non-winding posts 22 and the two first winding posts 24 extend from the first substrate 21 in the same direction (e.g., the X-axis direction), forming a comb-like structure. Specifically, the first substrate 21 is generally in the shape of a plate, while the first non-winding posts 22 and the first winding posts 24 are columnar structures extending from the surface of the first substrate 21.

In this embodiment, the second core 30 is shown as a structure symmetrical to the first core 20, which also includes a second substrate 31, two second non-winding posts 32, and two second winding posts 34. When the coupled inductor 10A is assembled, the first core 20 and the second core 30 are joined in a face-to-face manner, such that the first non-winding posts 22 align with the second non-winding posts 32, and the first winding posts 24 align with the second winding posts 34, collectively forming a closed or nearly closed complete magnetic path. It is worth noting that in other unillustrated embodiments, the structure of the second core 30 can be simplified to a plate-shaped magnetic core; this type of structure is referred to as an EI-type core, which can also form an effective magnetic path and falls within the scope of the present invention.

The two first windings 50A, 50B (primary windings) correspond to the two power phases of a power converter, respectively. Each of the first windings 50A, 50B is made of a conductive material, such as copper with high conductivity, and can be a flat copper strip or copper sheet to facilitate the reduction of direct current resistance (DCR) and increase the current carrying capacity. As shown in FIG. 2 and FIG. 3, the first winding 50A is wound around one of the first winding posts 24, while the first winding 50B is wound around the other first winding post 24. These two first windings 50A, 50B are arranged side-by-side along the Z-axis direction.

The second winding 80 (secondary winding) plays the role of the compensation inductor in the TLVR architecture. The second winding 80 is also made of a conductive material, and its structure is designed as a larger U-shaped or annular conductor capable of simultaneously covering or enclosing the two first windings 50A, 50B. As shown in FIG. 3, the cross-section of the second winding 80 has a U-shape, with its opening facing the substrate of the core component. In terms of spatial layout, the at least two first windings 50A, 50B and the second winding 80 are stacked along a first direction, which is the Z-axis direction. Specifically, the second winding 80 is located on the outer side of the first windings 50A, 50B, while the first windings 50A, 50B are located on the inner side of the second winding 80.

Regarding the definition of the winding direction, as shown in the cross-section of FIG. 3, the current path of the first windings 50A, 50B (i.e., the winding direction) can be considered as forming a loop in the YZ plane. Similarly, the current path of the second winding 80 also forms a loop in the YZ plane. Therefore, a first winding direction of the at least two first windings 50A, 50B and a second winding direction of the second winding 80 are mutually parallel. This parallel winding direction configuration, combined with the shared magnetic path, enables strong magnetic coupling between the first windings and the second winding, which is the foundation for achieving high-performance TLVR transient response. When the current in one of the first windings changes, the resulting magnetic flux variation not only passes through its own core post but also through the space enclosed by the second winding, thereby inducing a voltage in the second winding and further influencing the other first winding, thus achieving the goal of all phases responding in concert.

Please refer to FIG. 4, which shows the dimensional parameters of the first core 20 in more detail. In this embodiment, the first substrate 21 has a thicknessD1 and a height H1. The height H1 refers to the length along the Y-axis direction. The first winding post 24 has a widthD2 and a height H2. The height H2 refers to the height along the Y-axis direction. According to a preferred embodiment of the present invention, the design of these dimensions satisfies a specific relationship, wherein the product of the thickness D1 and the height H1 of the first substrate 21 is greater than the product of the width D2 and the height H2 of any first winding post 24 (i.e., H1 * D1 > H2 * D2). Here, the product can be considered to represent the cross-sectional area of that part in the XY plane or YZ plane. The advantage of this design is that a relatively thick and wide first substrate 21 can provide a more stable mechanical support structure and constitute a magnetic flux path with low reluctance, which helps the smooth flow of magnetic flux, thereby enhancing the overall performance of the inductor.

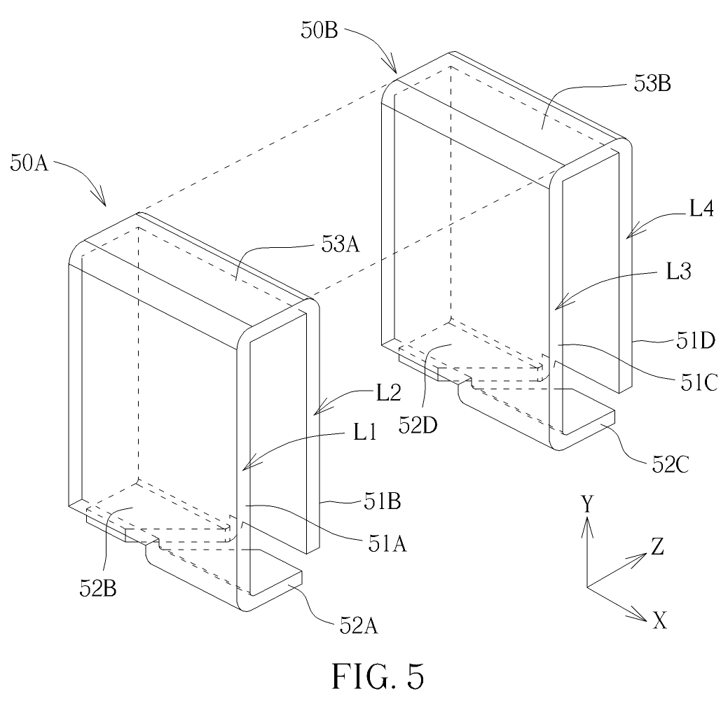

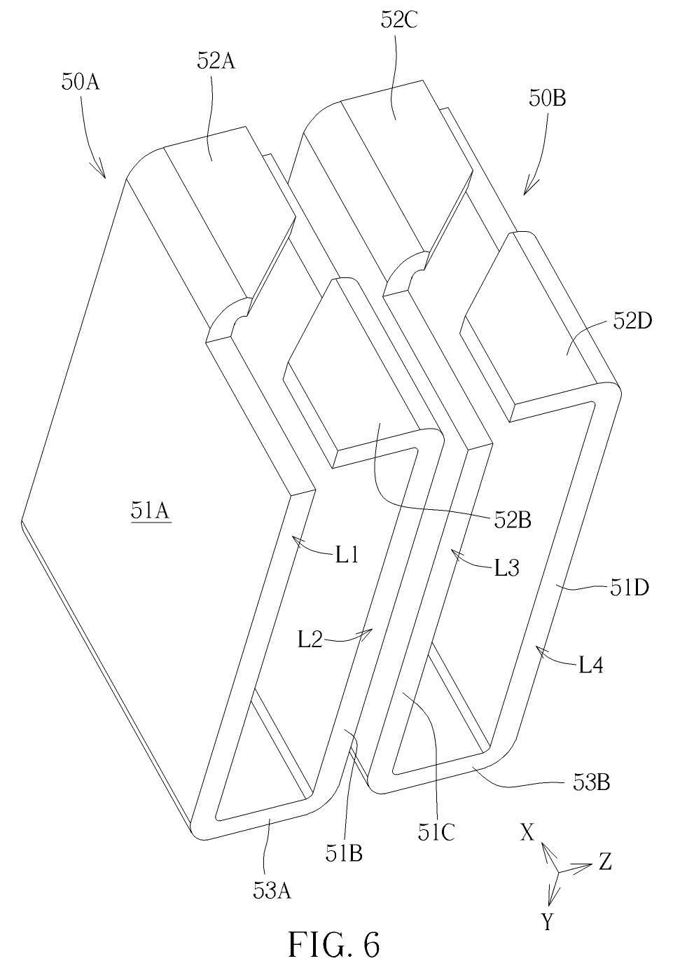

Next, please refer to FIG. 3, FIG. 5, and FIG. 6 for a more in-depth understanding of the detailed structure of the windings. Here, the first winding 50A is used as a representative example for description; the first winding 50B has a symmetrical or similar structure. The first winding 50A includes a first inner leg L1 and a second inner leg L2. As shown in the exploded view of FIG. 5, the first inner leg L1 includes a first inner side plate 51A and a first inner bottom plate 52A; the second inner leg L2 includes a second inner side plate 51B and a second inner bottom plate 52B. During assembly, one first winding post 24 is disposed between the first inner leg L1 and the second inner leg L2. The first inner bottom plate 52A extends from the bottom end of the first inner side plate 51A toward the second inner leg L2, while the second inner bottom plate 52B extends from the bottom end of the second inner side plate 51B toward the first inner leg L1. Importantly, the ends of the first inner bottom plate 52A and the second inner bottom plate 52B are spaced apart from each other and do not make direct contact, forming an opening.

Similarly, the other first winding 50B includes a third inner leg L3 and a fourth inner leg L4. The third inner leg L3 includes a third inner side plate 51C and a third inner bottom plate 52C; the fourth inner leg L4 includes a fourth inner side plate 51D and a fourth inner bottom plate 52D. The third inner bottom plate 52C extends toward the fourth inner leg L4, and the fourth inner bottom plate 52D extends toward the third inner leg L3, with the two also being spaced apart from each other.

Correspondingly, the structure of the second winding 80 includes a top plate 81, a first outer leg B1, and a second outer leg B2. The first outer leg B1 includes a first outer side plate 82 and a first outer bottom plate 84; the second outer leg B2 includes a second outer side plate 83 and a second outer bottom plate 85. As shown in FIG. 3, the first outer side plate 82 and the second outer side plate 83 are located on the outer sides of the first windings 50A and 50B, respectively. It is noteworthy that the extension direction of the first outer bottom plate 84 is opposite to that of the first inner bottom plate 52A (i.e., extending outward), and the extension direction of the second outer bottom plate 85 is opposite to that of the fourth inner bottom plate 52D (also extending outward). This design, where the terminals (bottom plates) of the inner and outer windings extend in opposite directions, greatly increases the physical distance between endpoints of different potentials, effectively enhancing the creepage distance, thereby significantly reducing the risk of electrical short circuits or flashovers in high-voltage or high-pollution environments. More specifically, the position where the first outer leg B1 (composed of 82, 84) is bent down to form an electrode is exactly offset from the position where the first inner leg L1 (composed of 51A, 52A) of the first winding 50A is bent down. Where the conductor is not bent down to form an electrode, the gap is naturally smaller; conversely, where the electrodes are formed, since the bending points of the two are spatially staggered, a larger gap is formed, thereby effectively reducing the risk of a short circuit.

To further enhance the structural integrity and mechanical strength of the winding, as shown in FIG. 5, the first winding 50A may further include a top plate 53A. The two side edges of the top plate 53A are connected to the top ends of the first inner side plate 51A and the second inner side plate 51B, respectively, such that the first winding 50A forms a nearly closed rectangular loop. Concurrently, a side edge of the first inner bottom plate 52A is connected to the bottom end of the first inner side plate 51A, and a side edge of the second inner bottom plate 52B is connected to the bottom end of the second inner side plate 51B. Similarly, the first winding 50B may also include a top plate 53B.

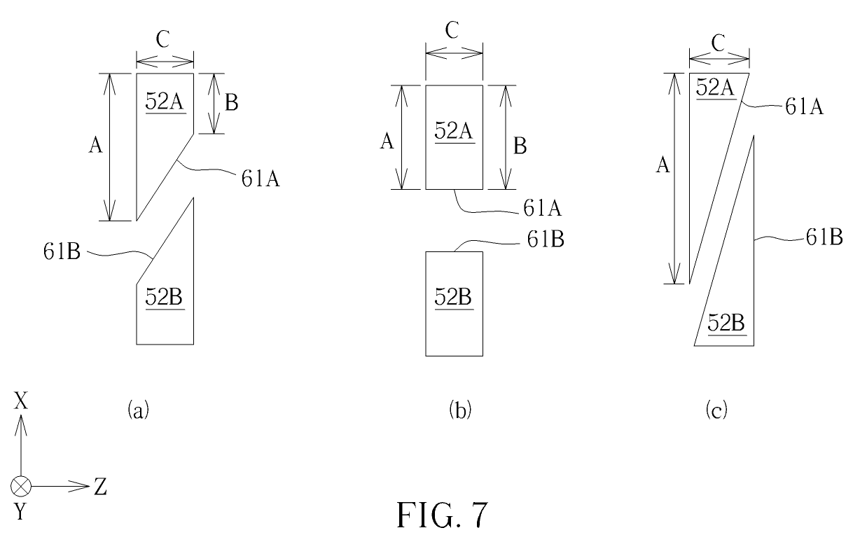

Please refer to FIG. 7, which illustrates schematic diagrams of different shape designs for the inner bottom plate of the first winding, where parts (a) to (c) of FIG. 7 respectively show three different embodiments. To optimize electrical performance and reduce the risk of short circuits, the shape of the inner bottom plates (taking the first inner bottom plate 52A and the second inner bottom plate 52B as an example) can be designed to be asymmetrical. As shown in part (a) of FIG. 7, the first inner bottom plate 52A has a first side edge A (connected to the inner side plate 61A) and a substantially parallel second side edge B (free end). In this embodiment, the length of the first side edge A is greater than the length of the second side edge B, causing the inner bottom plate to have a trapezoidal or other non-rectangular shape. Similarly, the second inner bottom plate 52B also has a longer first side edge A (connected to the inner side plate 61B) and a shorter second side edge B. This design is referred to as a staggered design. In this design, only about half the width of the full inner leg (e.g., the first inner leg L1) is bent down to the bottom to form the inner bottom plate (e.g., the first inner bottom plate 52A), while the other half is not. The positions where the adjacent inner legs (e.g., the second inner leg L2 and the third inner leg L3) are bent downward to form their respective inner bottom plates (e.g., the second inner bottom plate 52B and the third inner bottom plate 52C) are exactly offset, causing the solder joints on the PCB to also be staggered. This creates a larger gap at the staggered locations, further reducing the risk of a short circuit.

According to the experimental and simulation results of the present invention, the ratio of the length of the second side edge B to the length of the first side edge A of the first inner bottom plate 52A, and the ratio of the length of the second side edge B to the length of the first side edge A of the second inner bottom plate 52B, are preferably between 0.25 and 0.7. This ratio range can maximize the distance between the free ends of two opposing inner bottom plates (e.g., 52A and 52B) while ensuring a sufficient conductive cross-sectional area to reduce DCR. Furthermore, when the shortest linear distance between the first inner bottom plate 52A and the second inner bottom plate 52B is maintained between 0.7 millimeters and 1.4 millimeters, a balance between optimal insulation effect and manufacturing tolerance can be achieved. In a particularly preferred embodiment, this distance is 0.8 millimeters. Part (b) of FIG. 7 shows another possible shape where the inner bottom plate is rectangular, while part (c) of FIG. 7 shows another trapezoidal design. The core idea behind these designs is to increase the length of the potential short-circuit path through geometric variations. In an actual PCB layout, when these terminals of different potentials are soldered to solder pads, the molten solder tends to form a spherical shape due to surface tension. If the terminals are too close, a solder bridge can easily form, leading to a short circuit. The asymmetrical terminal design of the present invention ensures that the distance is guaranteed even at the closest points, thereby significantly reducing the probability of such manufacturing defects.

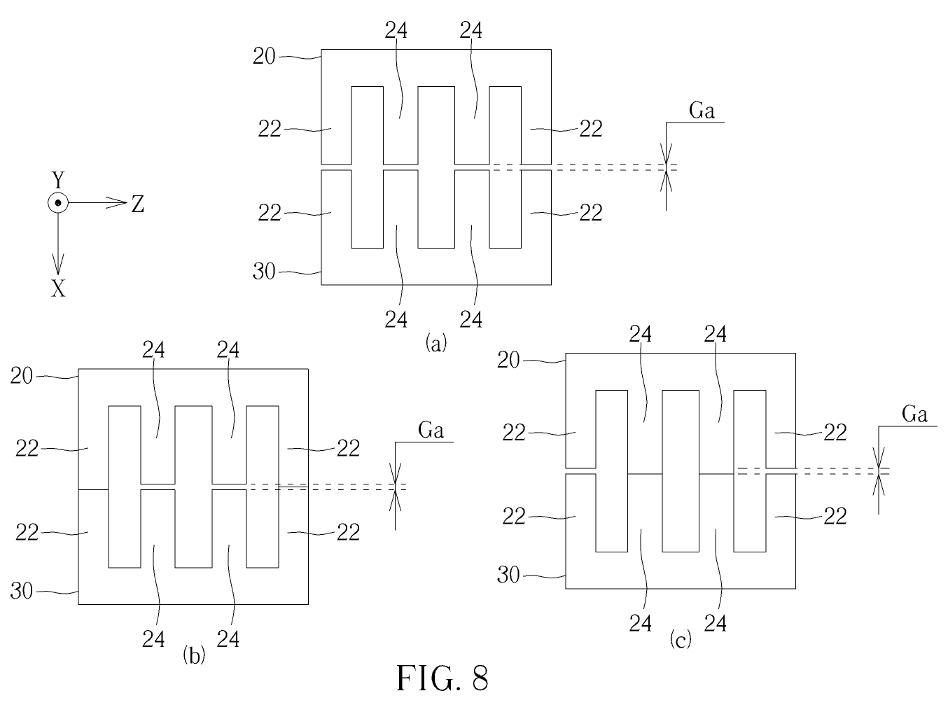

Please refer to FIG. 8, which illustrates schematic diagrams of different gap configurations for the coupled inductor, where parts (a) to (c) of FIG. 8 show three different gap configuration schemes. The air gap is a critical structure in inductor design used to store magnetic energy, prevent core saturation, and precisely adjust the inductance value. In part (b) of FIG. 8, an air gap is provided only between the central first winding post 24 and the corresponding second winding post 34, while the non-winding posts 22, 32 on the sides are in direct contact. In part (c) of FIG. 8, the situation is reversed: an air gap Ga is provided only between the non-winding posts 22, 32 on the sides, while the central winding posts 24, 34 are in direct contact. However, research conducted for the present invention has found that the two aforementioned non-uniform air gap configurations cause the inductance ratio between the primary and secondary windings to deviate from the ideal range (55% to 85%) required by the TLVR architecture. Specifically, the configuration with only a central post air gap (part (b) of FIG. 8) results in an excessively high ratio (e.g., a minimum value greater than 200%), while the configuration with only side post air gaps (part (c) of FIG. 8) results in an excessively low ratio (e.g., a maximum value less than 35%).

Therefore, the preferred embodiment of the present invention adopts a uniform air gap configuration as shown in part (a) of FIG. 8. That is, between the first core 20 and the second core 30, a first gap Ga is included between one of the two first non-winding posts 22 and a corresponding second non-winding post 32, and a second gap is included between one of the at least two first winding posts 24 and a corresponding second winding post 34, wherein the first gap Ga and the second gap have substantially the same thickness. This design, with equal air gaps in all magnetic path branches, ensures a uniform distribution of magnetic flux, allowing the self-inductance and mutual inductance of each winding to achieve an ideal balance, thereby precisely controlling the inductance ratio within the target range of 55% to 85%. To further stabilize the thickness of the air gap and adjust magnetic properties, a filler material, such as a plastic part, glass beads, or any material with a magnetic permeability between 1 Henry per meter and 10 Henries per meter, can be filled into the gap.

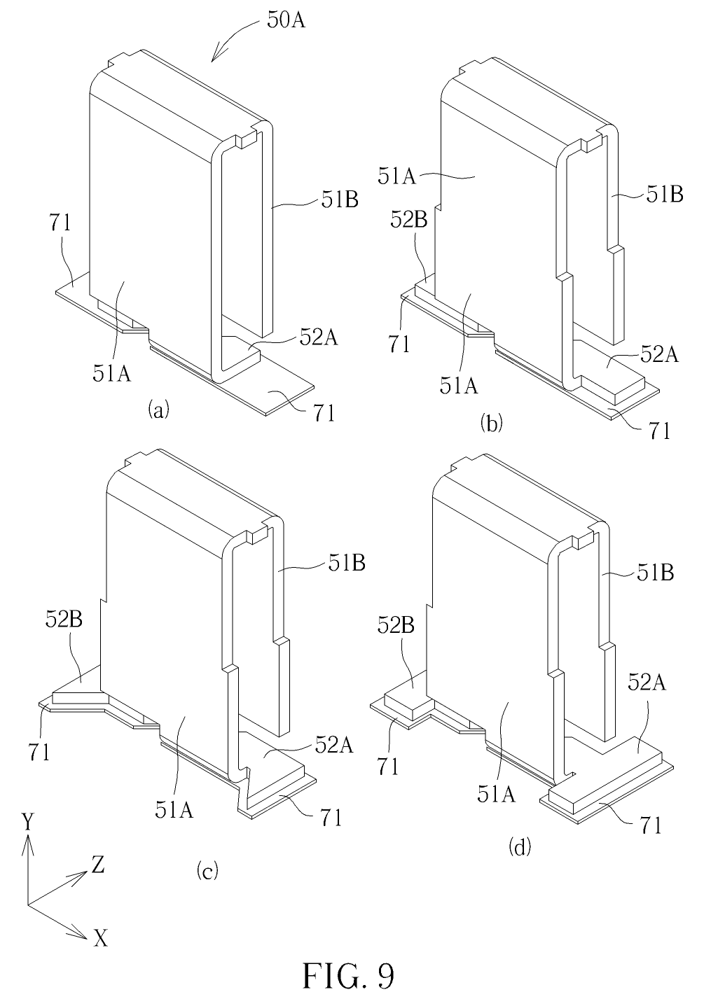

Please refer to FIG. 9, which illustrates schematic diagrams of different embodiments for the terminal extension structure of a first winding, where parts (a) to (d) of FIG. 9 show four different extension structures. In conventional designs, the terminals of a winding are typically formed by directly bending them downward from the main body. However, modern PCBs, in pursuit of high-density wiring, often have thinner copper foil layers, which leads to higher resistance values in the PCB traces. When a large current flows through these high-resistance paths, significant power loss and voltage drop occur, meaning the system-level DCR deteriorates. To solve this problem, the present invention proposes designing the terminals of the first winding 50A, namely its inner bottom plates 52A and 52B, to have a structure that extends horizontally outward. FIG. 9 show four different terminal extension designs for the first winding 50A. In the figures, the component symbol 71 represents a terminal on the printed circuit board, which can be a solder pad or a trace, with its shape designed to match the extension structure of the inner bottom plates52A, 52B. As shown, the extensions of the inner bottom plates 52A and 52B are not limited to a specific shape and can be quadrilateral (as shown in part (a) of FIG. 9), L-shaped (as shown in part (b) of FIG. 9), or various other shapes that can increase the soldering area (as shown in parts (c) and (d) of FIG. 9). When the extended inner bottom plates 52A and 52B are soldered onto the printed circuit board, they can cover wider or thicker corresponding terminals 71, effectively utilizing the lower-resistance paths on the PCB and thereby compensating for the high resistance caused by the thinner copper foil of the PCB itself. Experimental data shows that under the condition of a 1.5-ounce PCB copper thickness, adopting this extension scheme can improve the system equivalent DCR by more than 45%, significantly enhancing the overall power efficiency.

Furthermore, to ensure highly reliable operation, the conductor surfaces of all windings, including the first windings 50A, 50B and the second winding 80, can each be covered with an insulating layer, such as an insulating varnish or a polymer film, to prevent inter-turn short circuits within a winding or short circuits between a winding and the core.

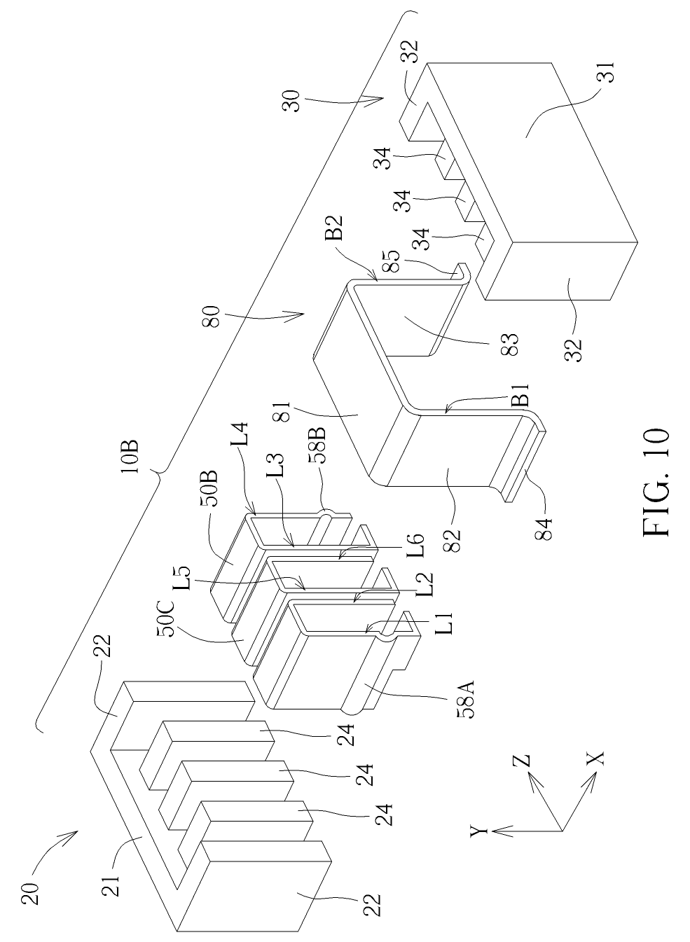

Please refer to FIG. 10 through FIG. 13, which illustrate a coupled inductor 10B according to a second embodiment of the present invention. This embodiment shows a three-phase coupled inductor whose basic structure and principle are similar to those of the first embodiment, but extended to support more power phases. The coupled inductor 10B mainly includes a core component (composed of a first core 20 and a second core 30), three first windings 50A, 50B, 50C (primary windings), and one common second winding 80 (secondary winding).

In this embodiment, the first core 20 includes a first substrate 21, two first non-winding posts 22, and three first winding posts 24 disposed therebetween. Correspondingly, the three first windings 50A, 50B, 50C are wound on these three first winding posts 24, respectively.

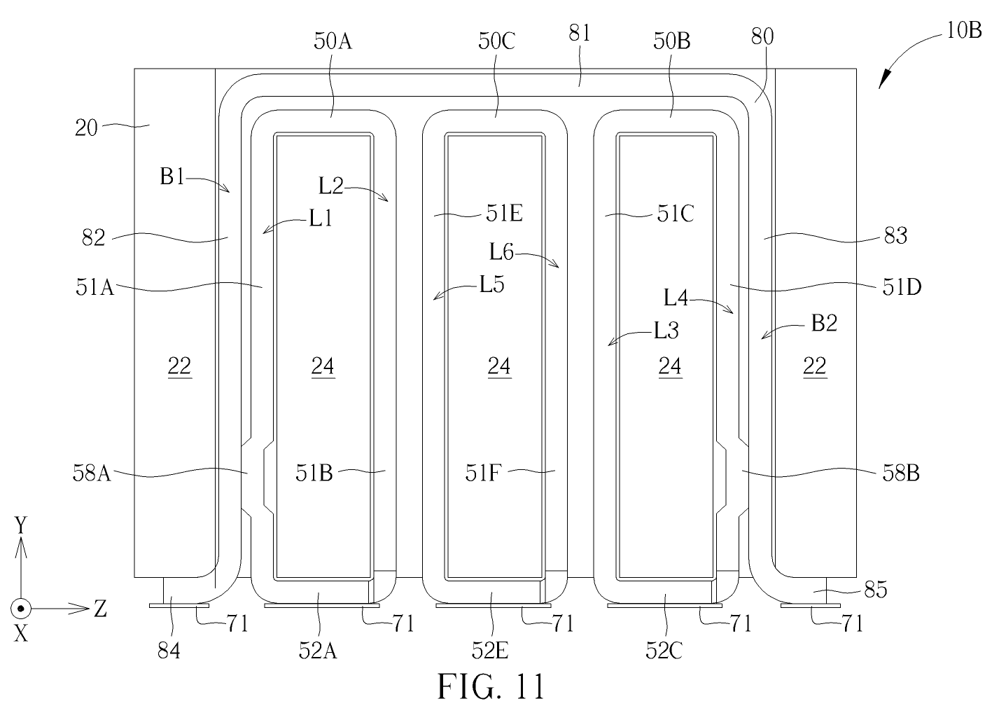

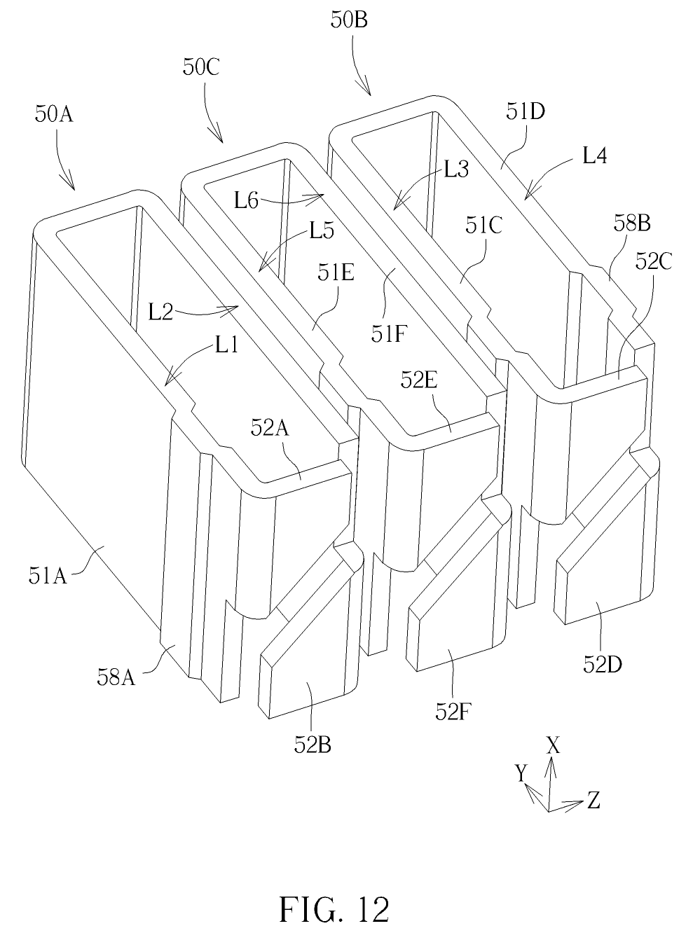

As shown in FIG. 11 and FIG. 12, the structure of these three first windings is similar to that in the first embodiment. In addition to the original first windings 50A and 50B, a third first winding 50C is added, disposed between the first winding 50A and the first winding 50B. The third first winding 50C also includes a fifth inner leg L5 and a sixth inner leg L6. The fifth inner leg L5 includes a fifth inner side plate 51E and a fifth inner bottom plate 52E; the sixth inner leg L6 includes a sixth inner side plate 51F and a sixth inner bottom plate 52F. Similarly, the fifth inner bottom plate 52E extends toward the sixth inner legL6, the sixth inner bottom plate 52F extends toward the fifth inner leg L5, and the two are spaced apart from each other.

It is particularly noteworthy that, as shown in FIG. 11 and FIG. 12, the two outermost first windings 50A and 50B each have an integral protrusion structure formed on their side plates facing the exterior of the coupled inductor 10B. Specifically, the first winding 50A includes a first protruding portion 58A, which protrudes from the outer surface of the first inner side plate 51A in the negative Z-axis direction. In contrast, the first winding 50B includes a second protruding portion 58B, which protrudes from the outer surface of the fourth inner side plate 51D in the positive Z-axis direction. The protrusion directions of these two protruding portions 58A and 58B are opposite.

The function of these protruding portions 58A, 58B is to serve as mechanical spacers or positioning structures. During the assembly process, when the first windings 50A, 50B, 50C are placed inside the second winding 80, the first protruding portion 58A abuts against an inner wall of the first outer side plate 82 of the second winding 80, and the second protruding portion 58B abuts against an inner wall of the second outer side plate 83 of the second winding 80. In this way, a minimum and fixed distance is established and maintained between the primary windings (50A, 50B) and the secondary winding (80) along the Z-axis direction. This preset distance ensures a sufficient insulating gap between them, effectively preventing the risk of electrical short circuits caused by being too close, even under the influence of factors such as manufacturing tolerances, vibrations, or thermal expansion and contraction, thereby significantly enhancing the overall reliability of the coupled inductor 10B.

The structure of the second winding 80 is also correspondingly expanded, with the width of its top plate 81 increased to be able to cover all three first windings 50A, 50B, 50C simultaneously. The structures of its first outer leg B1 and second outer leg B2 are the same as in the first embodiment. As shown in FIG. 11, the inner side plates 51A, 51E, 51F, 51C, 51B, 51D of the first windings 50A, 50C, 50B are all accommodated within the space enclosed by the top plate 81, the first outer side plate 82, and the second outer side plate 83 of the second winding 80.

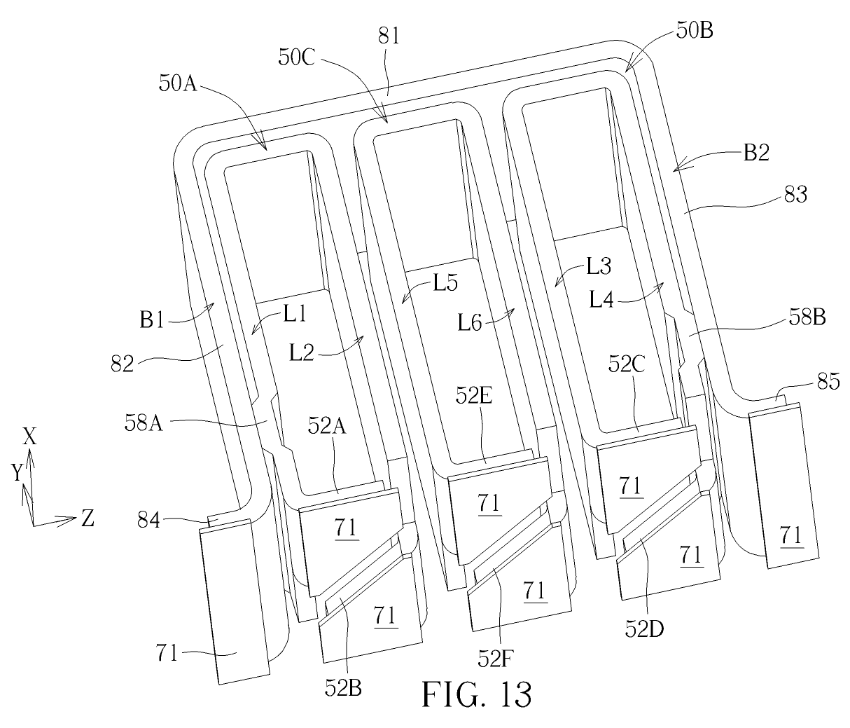

FIG. 13 shows the terminal layout of the three-phase coupled inductor 10B. It can be seen that the inner bottom plates (terminals) 52Ato 52F of the three first windings 50A, 50B, 50C, as well as the outer bottom plates (terminals) 84, 85 of the second winding 80, all adopt the aforementioned staggered and asymmetrical design to ensure sufficient insulation distance between terminals of different potentials and prevent short circuits. This embodiment demonstrates that the architecture of the present invention has good scalability and can be easily extended from two phases to three or even more phases to meet the demand for the number of power phases in different applications, while maintaining the characteristics of a compact structure and superior performance.

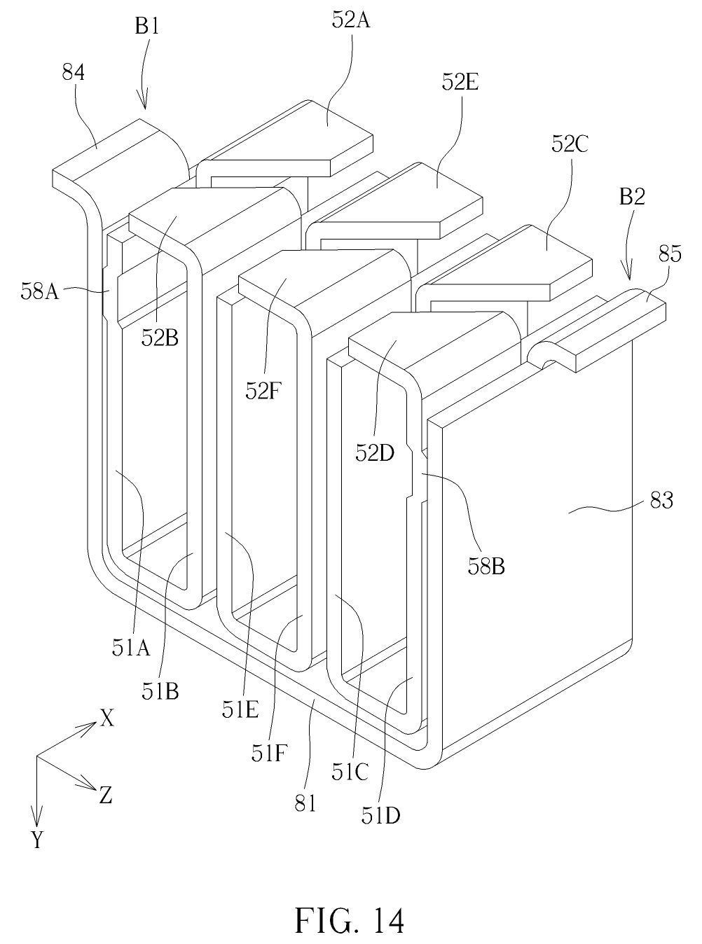

Please refer to FIG. 14, which illustrates a perspective view of a winding structure according to another embodiment of the present invention. This winding structure is likewise used for a three-phase coupled inductor and includes three first windings 50A, 50B, 50C and a second winding 80. The difference between this embodiment and the embodiments of FIGS. 11 to 13 is that this embodiment further incorporates the two outer bottom plates 84 and 85 of the second winding 80 into the original staggered design of the inner bottom plates 52A to 52F, so as to maximize the electrical spacing between the various bottom plates and thereby reduce the risk of a short circuit. Specifically, in the embodiment of FIGS. 11 to 13, the widths of the outer bottom plates 84 and 85 along the X-axis direction are equal to the widths of the first outer side plate 82 and the second outer side plate 83 along the X-axis direction. In contrast, in the embodiment of FIG. 14, the widths of the outer bottom plates 84 and 85 along the X-axis direction are less than half of the widths of the first outer side plate 82 and the second outer side plate 83 along the X-axis direction. As shown in FIG. 14, the respective projections of the outer bottom plate 84 and the inner bottom plate 52A onto the XZ plane along a direction parallel to the Y-axis do not overlap each other, and the respective projections of the outer bottom plate 85 and the inner bottom plate 52D onto the XZ plane along a direction parallel to the Y-axis also do not overlap each other. Additionally, the bottom plates between adjacent legs are intentionally staggered. For example, for the adjacent first outer leg B1 and first inner leg L1, their outer bottom plate 84 and inner bottom plate 52A are staggered; for the adjacent second outer leg B2 and fourth inner leg L4, their outer bottom plate 85 and inner bottom plate 52D are staggered. As for the arrangement of the inner bottom plates 52A to 52F of the three first windings 50A, 50B, 50C, it is the same as the arrangement in the embodiment of FIGS. 11 to 13, and therefore will not be described again. Additionally, it can be seen from FIG. 14 that the outer bottom plate 84, the inner bottom plate 52B, the inner bottom plate 52F, and the inner bottom plate 52D extend in the negative Z-axis direction, while the outer bottom plate 85, the inner bottom plate 52C, the inner bottom plate 52E, and the inner bottom plate 52A extend in the positive Z-axis direction.

In summary, the coupled inductor disclosed in the present invention, through its innovative multiphase integrated core structure, uniform air gap configuration, and sophisticated winding and terminal geometric designs, successfully solves the problems of excessive space consumption of discrete TLVR solutions and the design difficulties of integrated solutions in the prior art. The present invention not only significantly reduces component volume and improves PCB space utilization, but also achieves excellent transient response performance, lower direct current resistance, and higher system reliability through optimized magnetic and circuit designs. It perfectly meets the stringent requirements of modern high-performance computing systems for power supplies and has extremely high industrial application value.

The foregoing descriptions are merely preferred embodiments of the present invention, and any equivalent variations and modifications made in accordance with the scope of the patent application of the present invention should fall within the scope of coverage of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A coupled inductor, comprising:
a core component, comprising:
a first core, comprising a first substrate, two first non-winding posts, and at least two first winding posts disposed between the two first non-winding posts, wherein the two first non-winding posts and the at least two first winding posts are connected to the first substrate; and
a second core;
at least two first windings, each of the first windings being wound on a corresponding first winding post; and
a second winding covering the at least two first windings;
wherein the at least two first windings and the second winding are disposed along a first direction; and
wherein a first winding direction of the at least two first windings and a second winding direction of the second winding are mutually parallel.

2. The coupled inductor as claimed in claim 1, wherein a product of a thickness and a height of the first substrate is greater than a product of a width and a height of any of the first winding posts.

3. The coupled inductor as claimed in claim 1, wherein one of the at least two first windings comprises a first inner leg and a second inner leg, and another of the at least two first windings comprises a third inner leg and a fourth inner leg;
wherein the first inner leg comprises a first inner side plate and a first inner bottom plate, the second inner leg comprises a second inner side plate and a second inner bottom plate, the first inner bottom plate extends toward the second inner leg, the second inner bottom plate extends toward the first inner leg, and the first inner bottom plate and the second inner bottom plate are spaced apart from each other;
wherein the third inner leg comprises a third inner side plate and a third inner bottom plate, the fourth inner leg comprises a fourth inner side plate and a fourth inner bottom plate, the third inner bottom plate extends toward the fourth inner leg, the fourth inner bottom plate extends toward the third inner leg, and the third inner bottom plate and the fourth inner bottom plate are spaced apart from each other; and
wherein the second winding comprises a top plate, a first outer leg, and a second outer leg, the first outer leg comprises a first outer side plate and a first outer bottom plate, the second outer leg comprises a second outer side plate and a second outer bottom plate, the first outer bottom plate extends in a direction opposite to the first inner bottom plate, and the second outer bottom plate extends in a direction opposite to the fourth inner bottom plate.

4. The coupled inductor as claimed in claim 3, wherein one first winding post is disposed between the first inner leg and the second inner leg, and another first winding post is disposed between the third inner leg and the fourth inner leg.

5. The coupled inductor as claimed in claim 3, wherein a width of the first outer bottom plate is less than a width of the first outer side plate, and the first outer bottom plate and the first inner bottom plate are staggered relative to each other; and
wherein a width of the second outer bottom plate is less than a width of the second outer side plate, and the second outer bottom plate and the fourth inner bottom plate are staggered relative to each other.

6. The coupled inductor as claimed in claim 3, further comprising a third first winding disposed between the one of the at least two first windings and the another of the at least two first windings, wherein the third first winding comprises a fifth inner leg and a sixth inner leg, the fifth inner leg comprises a fifth inner side plate and a fifth inner bottom plate, the sixth inner leg comprises a sixth inner side plate and a sixth inner bottom plate, the fifth inner bottom plate extends toward the sixth inner leg, the sixth inner bottom plate extends toward the fifth inner leg, and the fifth inner bottom plate and the sixth inner bottom plate are spaced apart from each other.

7. The coupled inductor as claimed in claim 3, wherein the one of the at least two first windings further comprises a first protruding portion, the first protruding portion protrudes from an outer surface of the first inner side plate and abuts the first outer side plate of the second winding; and
wherein the another of the at least two first windings further comprises a second protruding portion, the second protruding portion protrudes from an outer surface of the fourth inner side plate and abuts the second outer side plate of the second winding.

8. The coupled inductor as claimed in claim 7, wherein each of the first inner bottom plate and the second inner bottom plate has a first side edge and a second side edge parallel to the first side edge, and a length of each the first side edge is greater than a length of a corresponding the second side edge.

9. The coupled inductor as claimed in claim 8, wherein a ratio of the length of the second side edge of the first inner bottom plate to the length of the first side edge of the first inner bottom plate is between 0.25 and 0.7 and a ratio of the length of the second side edge of the second inner bottom plate to the length of the first side edge of the second inner bottom plate is between 0.25 and 0.7.

10. The coupled inductor as claimed in claim 9, wherein a distance between the first inner bottom plate and the second inner bottom plate is between 0.7 millimeters and 1.4 millimeters.

11. The coupled inductor as claimed in claim 10, wherein the distance between the first inner bottom plate and the second inner bottom plate is 0.8 millimeters.

12. The coupled inductor as claimed in claim 7, wherein in a top-down view of the coupled inductor, the first inner bottom plate and the second inner bottom plate are disposed between the first inner side plate and the second inner side plate.

13. The coupled inductor as claimed in claim 1, wherein one of the at least two first windings comprises a top plate, a first inner leg and a second inner leg, wherein two side edges of the top plate are respectively connected to the first inner leg and the second inner leg.

14. The coupled inductor as claimed in claim 1, wherein the second core comprises a second substrate, two second non-winding posts, and at least two second winding posts disposed between the two second non-winding posts, wherein the two second non-winding posts and the at least two second winding posts are connected to the second substrate, and each of the first windings is wound on a second winding post corresponding to one of the first winding posts.

15. The coupled inductor as claimed in claim 1, wherein the second core comprises a second substrate, two second non-winding posts, and at least two second winding posts disposed between the two second non-winding posts, wherein the two second non-winding posts and the at least two second winding posts are connected to the second substrate, and a first gap is between one of the two first non-winding posts and a second non-winding post corresponding to the one of the two first non-winding posts, and a second gap is between one of the at least two first winding posts and a second winding post corresponding to the one of the first winding posts, wherein the first gap and the second gap have the same thickness.

16. The coupled inductor as claimed in claim 15, further comprising a filler material filled in the first gap and the second gap, wherein a magnetic permeability of the filler material is between 1 Henry per meter and 10 Henries per meter.

17. The coupled inductor as claimed in claim 1, wherein surfaces of the at least two first windings and the second winding are respectively covered with an insulating layer.

18. The coupled inductor as claimed in claim 1, wherein an inductance ratio of any of the first windings to the second winding is between 55% and 85%.
